(19) United States
(12) Patent Application Publication
(10) Pub. No.: US 2007/0258590 A1
(43) Pub. Date: Nov. 8, 2007

(54) Method and system for triple play service control

(75) Inventors: Robert J. Beaton, Apohaqui (CA); Stephen Nelson West, Morrisdale (CA); Jeff Furlong, Grand Bay-Westfield (CA)

Correspondence Address: KRAMER & AMADO, P.C., 1725 DUKE STREET, SUITE 240, ALEXANDRIA, VA, 22314, US

(73) Assignee: ALCATEL, Paris (FR)

(21) Appl. No.: 11/415,209

(22) Filed: May 2, 2006

(51) Int. Cl. H04N 7/167

(52) U.S. Cl. 380/212

(57) ABSTRACT

A method for controlling access to triple play services provided through a server over a network to a target system, the method comprising: receiving a signal from a user to select a service from a list of the services displayed on a display screen of a data processing system; receiving a signal from the user to select a control for configuring access to the service from a list of controls displayed on the display screen, each control representing a respective strategy for controlling access to the service; receiving a signal from the user providing respective parameter values for parameters in a list of parameters displayed on the display screen for the control, the parameters for controlling access to the service for the target system; and, sending the parameter values to the server, wherein the server controls access to the service for the target system in accordance with the parameter values.

### FIELD OF THE INVENTION

This invention relates to triple play service, and more specifically, to a method and system for controlling access to triple play services.

### BACKGROUND OF THE INVENTION

In telecommunications, the term “triple play service” or “triple play” refers to the provision of the three services, namely, high-speed Internet, television (i.e., video-on-demand or regular broadcasts), and telephone service, over a single broadband connection. Triple play service is offered by cable television operators as well as by telecommunication operators. For a telephone local exchange carrier (“LEC”), triple play service is delivered using a combination of optical fiber and digital subscriber line (“DSL”) technologies to their residential customer subscriber base. This configuration uses fiber communications to reach distant locations and uses DSL over an existing plain old telephone serve (“POTS”) twisted pair cable as last mile access to the subscriber's home. Cable television operators use a similar architecture called hybrid fibre coaxial (“HFC”) to provide subscriber homes with broadband, but use the available coaxial cable rather than a twisted pair for the last mile transmission standard. Subscriber homes can be in a residential environment, multi-dwelling units, or even in business offices.

Using DSL over twisted pair, television content is delivered using Internet Protocol (“IP”) television (“IPTV”) where the content is streamed to the subscriber in a MPEG-2 (“Moving Pictures Expert Group”−2) transport format. With IPTV, digital television service is delivered to subscribing consumers using IP over a broadband connection. On an HFC network, television may be a mixture of analog and digital television signals. A set-top-box (“STB”) is used at the subscriber's home to allow the subscriber to control viewing and order new video services such as movies on demand. Internet service is delivered via asynchronous transfer mode (“ATM”) or data over cable service interface specification (“DOCSIS”), typically provided as a 10BASE-T (i.e., 10 Mbit/s baseband over twisted pair) Ethernet port to the subscriber. Voice can be delivered using a traditional POTS interface as part of the legacy telephone network or can be delivered using voice over IP (“VoIP”). In a HFC network, voice is delivered using VoIP.

Some service providers also provide Ethernet-to-the-home and fiber-to-the-home networks which support triple play service and bypass the disadvantages of adapting broadband transmission to legacy networks. This is particularly common in green field developments where capital expenditures are reduced by deploying one network to deliver all services.

Triple play has led to the term “quadruple play” where wireless communications is introduced as another media to deliver video, Internet, and voice content. Advances in both code division multiple access (“CDMA”) and global system for mobile communications (“GSM”) standards, utilizing third generation (“3G”), fourth generation (“4G”), or universal mobile telecommunications service (“UMTS”) mobile telephone technologies, allow service operators to provide quadruple play services. The grouping together of services (such as triple or quadruple play) is referred to as “multi-play”.

It has been said that the main challenges in offering triple play relate to backend processes and subscriber support. With respect to technical challenges, voice, video and high speed data all have different characteristics and place different burdens on the network that provides access to these services. For example, voice services are greatly affected by jitter, whereas packet loss or packet reordering has a greater affect on video and data services. Using a shared network resource such as cable or DSL requires that the network equipment used employs quality of service mechanisms.

With respect to subscriber support, subscribers are beginning to demand control over the content provided through their triple play service. In particular, parents have come to demand control (i.e., parental control) over content available to their children. At present, parents (or other guardians) have no way of controlling products and services from a single point for their families and children. Some stand-alone parental controls are available for some products, but other products simply do not have such controls. Consequently, parents are often faced with services that may be disruptive to their family life having content that is not suitable for their children (e.g., video-on-demand movies, etc.) and they may receive large bills for services that their children have accessed but for which they did not approve (e.g., long distance telephone calls, etc.).

With respect to parental control in general, U.S. Pat. No. 6,662,365 to Sullivan, et al. (“Sullivan”), provides a system and method for “unified parental locks”. In particular, Sullivan provides a system and method for controlling a plurality of parental control subsystems within an entertainment system. The system includes a computer interfaced to a plurality of audio and/or audiovisual devices, wherein at least two of the audio and/or audiovisual devices within the system each comprise a native parental control subsystem or locking mechanism having adjustable parameters. A software locking mechanism operates the computer to allow a user to input one or more general parental control parameters and then sets the adjustable parameters of each native parental control subsystem within the system by mapping the parental control parameters onto each separate, native mechanism for each device. Thus, Sullivan provides a system for managing parental controls for a home entertainment system (e.g., TV, VCR, DVD, and PC). The parental control in Sullivan is based on “ratings” such as Motion Picture Association of America (“MPAA”) ratings (e.g., PG-13, R, etc.). Thus, while systems such as that provided by Sullivan may provide control access to movies based on their ratings, they do not provide access control for triple play service that may include services (e.g., telephone service) that do not have associated ratings or to which ratings are inapplicable.

A need therefore exists for an improved method and system for controlling access to triple play services. Accordingly, a solution that addresses, at least in part, the above and other shortcomings is desired.

### SUMMARY OF THE INVENTION

According to one aspect of the invention, there is provided a method for controlling access to triple play services provided through a server over a network to a target system, the method comprising: receiving a signal from a user to select a service from a list of the services displayed on a display screen of a data processing system; receiving a signal from the user to select a control for configuring access to the service from a list of controls displayed on the display screen, each control representing a respective strategy for controlling access to the service; receiving a signal from the user providing respective parameter values for parameters in a list of parameters displayed on the display screen for the control, the parameters for controlling access to the service for the target system; and, sending the parameter values to the server, wherein the server controls access to the service for the target system in accordance with the parameter values.

In the above method, the services maybe one or more of television service, wired telephone service, cellular telephone service, wireless data service, wireless email service, Internet service, and short message service. The controls for the television service may be one or more of channel selection, duration of usage, time of usage, and value of usage. The parameters for the time of usage control may be one or more of day of week and total hours. The data processing system may be collocated with the target system. The network may be an IP based network. And, the data processing system and the target system may be one or more of a television, a computer, a wireless device, a cellular telephone, a personal digital assistant, and a set-top box.

In accordance with further aspects of the present invention there is provided an apparatus such as a data processing system, a method for adapting this system, as well as articles of manufacture such as a computer readable medium having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a communications system for providing triple play service in accordance with an embodiment of the invention;

FIG. 2 is a block diagram illustrating a data processing system adapted to implement an embodiment of the invention;

FIG. 3 is a screen capture illustrating an options menu for triple play parental control in accordance with an embodiment of the invention;

FIG. 4 is a screen capture illustrating a television service control options menu in accordance with an embodiment of the invention;

FIG. 5 is a screen capture illustrating a television service time limits configuration window in accordance with an embodiment of the invention;

FIG. 6 is a screen capture illustrating the options menu of FIG. 3 as displayed on the display screen of a personal digital assistant (“PDA”) in accordance with an embodiment of the invention; and,

FIG. 7 is a flow chart illustrating operations of modules within the memory of a data processing system for controlling access to triple play services provided through a server over a network to a target system, in accordance with an embodiment of the invention.

It will be noted that throughout the appended drawings, like features are identified by like reference numerals.

### DETAILED DESCRIPTION OF THE PREFERRED EMBODIMENTS

In the following description, details are set forth to provide an understanding of the invention. In some instances, certain software, circuits, structures and techniques have not been described or shown in detail in order not to obscure the invention. The term “data processing system” is used herein to refer to any machine for processing data, including the personal computers (“PCs”), servers, handheld electronic devices, personal digital assistants (“PDAs”), wireless communication devices, cellular telephones, wired telephones, remote controls, and set-top boxes described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention.

The present invention provides a method and system for parental control, including control based on time of day, amount of time, costs, cost allowances, parties to a conversation or exchange, etc., that is applicable to all triple play services including wired and wireless communication device based services. In the following, the term “triple play” will refer to both “quadruple play” and “multi-play” services.

In particular, the present invention provides a method and system that allows parents (or other guardians) to control access to and content of all service provider (“SP”) based services (i.e., triple play services) for family members from a single interface. In doing so, the present invention provides true triple play parental control for TV, wired telephone, cellular or wireless telephone, Internet, email, games, messaging (e.g., instant messaging (“IM”) via Microsoft Network™ (“MSN”) Messenger, short message service (“SMS”) via GSM, etc.), and other services all from a single interface point, user interface, or control panel. With the present invention, parents and guardians can access this parental control panel from any service that can support it (e.g., PC, TV, PDA, cellular telephone, etc.) allowing for easy changes and updates. A parent/guardian can control access to and content from the Web (i.e., amount of surfing time, what time of day, locations/sites accessible, etc.), telephone/cellular telephone usage (i.e., talk time, time of day, up to what dollar amount allowed, dollar allowance, etc.), television usage (i.e., up to what dollar amount allowed, dollar allowance, amount of time, time of day, access to channels, etc.), SMS/MSN usage (i.e., amount of time, time of day, to what parties, etc.), and any other consumer product offered by the SP (e.g., games, other communication tools and devices such as wireless email via Blackberry™ or other PDA, etc.).

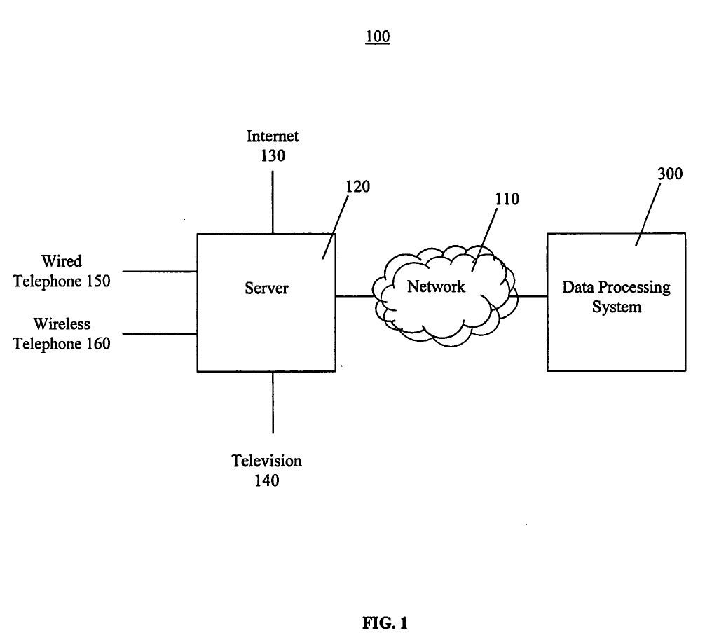

FIG. 1 is a block diagram illustrating a communications system 100 for providing triple play service in accordance with an embodiment of the invention. The communications system 100 includes a server 120 coupled to a data processing system 300 over a network 110. The server 120 may be maintained by a service provider (“SP”) to provide triple play service to a subscriber or user of the data processing system 300. The server 120 accesses Internet 130, television 140, wired telephone 150, and wireless telephone or cellular 160 networks for providing corresponding services to the data processing system 300 in accordance with control messages received from the data processing system 300 over the network. The network 110 may be an IP based network (i.e., in the case of Internet, television, and wired telephone services) and/or a wireless network (i.e., in the case of wireless telephone or cellular services). The network 110 may include routers, switches, base stations, antennae, and other network devices (not shown).

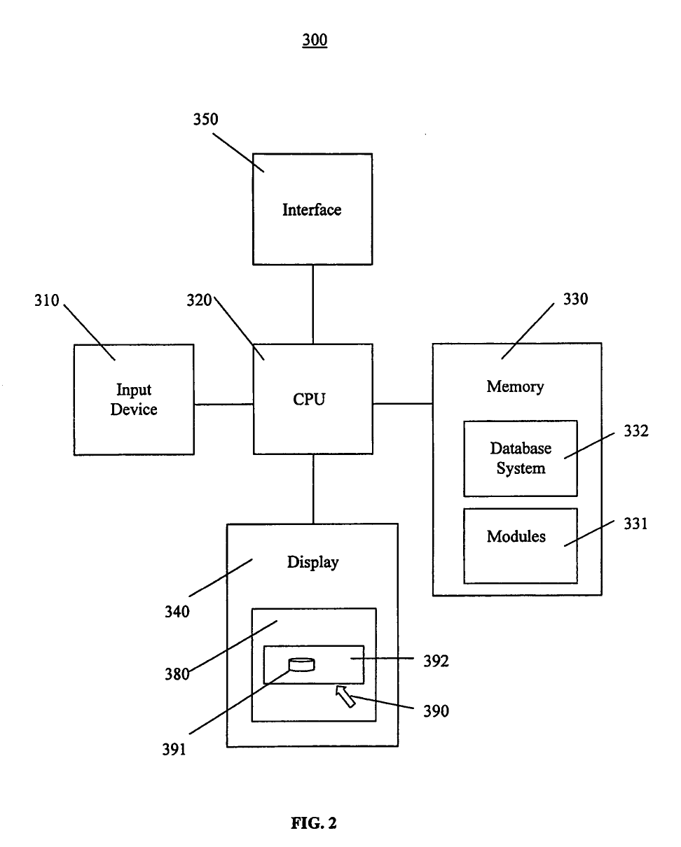

FIG. 2 is a block diagram illustrating a data processing system 300 adapted to implement an embodiment of the invention. The data processing system 300 is suitable for operation as a personal computer (“PC”), server 120, handheld electronic device, personal digital assistant (“PDA”), wireless communication device, cellular telephone, wired telephone, remote control, and set-top box. The data processing system 300 includes a central processing unit (“CPU”) 320, memory 330, and an interface device 350 and may optionally include an input device 310 and a display 340. The CPU 320 may include dedicated coprocessors and memory devices. The memory 330 may include RAM, ROM, disk devices, and databases. The interface device 350 may include a network connection (e.g., an IP based network connection and/or a wireless network connection). The input device 310 may include a keyboard, a mouse, a trackball, a remote control unit, or a similar device. And, the display 340 may include a computer screen, television screen, terminal device, or a hardcopy producing output device such as a printer or plotter. The data processing system 300 is adapted for communicating with other data processing systems (e.g., 120) over a network 110 via the interface device 350. The data processing system 300 may include a database system 332 for storing and accessing network topology and programming information. The database system 332 may include a database management system (“DBMS”) and a database and may be stored in the memory 330 of the data processing system 300. The data processing system 300 has stored therein data representing sequences of instructions which when executed cause the method described herein to be performed. Of course, the data processing system 300 may contain additional software and hardware a description of which is not necessary for understanding the invention.

The data processing system 300 may be a server system or a personal computer (“PC”) system. The CPU 320 of the system 300 is operatively coupled to memory 330 which stores an operating system (not shown) for general management of the system 300. The interface 350 may be used for communicating to external data processing systems (e.g., server 120 in FIG. 1) through a network 110. The system 300 may include application server software (not shown) for developing and managing distributed applications. The CPU 320 of the system 300 is typically coupled to one or more devices 310 for receiving user commands or queries and for displaying the results of these commands or queries to the user on a display 340. As mentioned, the memory 330 may include a variety of storage devices including internal memory and external mass storage typically arranged in a hierarchy of storage as understood to those skilled in the art.

A user may interact with the data processing system 300 and its hardware and software modules 331 using a graphical user interface (“GUI”) 380. The GUI 380 may be used for monitoring, managing, and accessing the data processing system 300. GUIs are supported by common operating systems and provide a display format which enables a user to choose commands, execute application programs, manage computer files, and perform other functions by selecting pictorial representations known as icons, or items from a menu through use of an input or pointing device such as a mouse 310. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input or pointing device (e.g., a mouse) 310 to position a pointer or cursor 390 over an object 391 and by “clicking” on the object 391.

Typically, a GUI based system presents application, system status, and other information to the user in “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

Thus, the data processing system 300 includes computer executable programmed instructions for directing the system 300 to implement the embodiments of the present invention. The programmed instructions may be embodied in one or more hardware modules or software modules 331 resident in the memory 330 of the data processing system 300. Alternatively, the programmed instructions may be embodied on a computer readable medium (such as a CD disk or floppy disk) which may be used for transporting the programmed instructions to the memory 330 of the data processing system 300. Alternatively, the programmed instructions maybe embedded in a computer-readable signal or signal-bearing medium that is uploaded to a network by a vendor or supplier of the programmed instructions, and this signal or signal-bearing medium may be downloaded through an interface (e.g., 350) to the data processing system 300 from the network by end users or potential buyers.

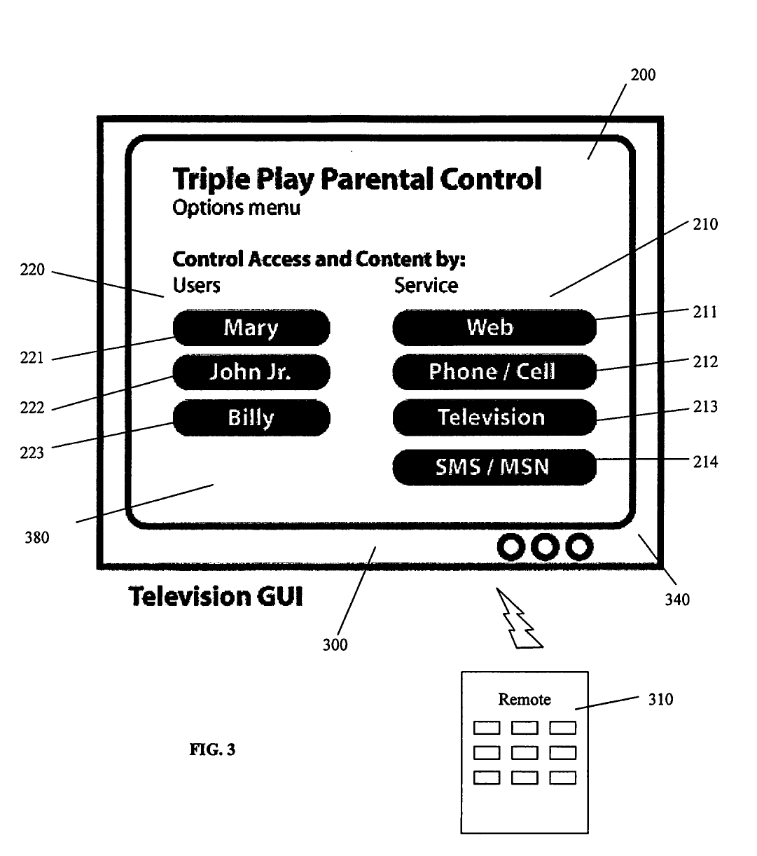

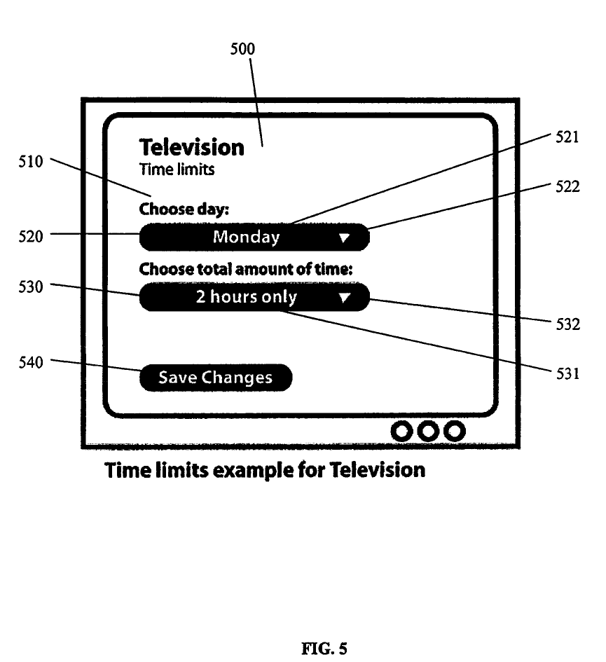

FIG. 3 is a screen capture illustrating an options menu 200 for triple play parental control in accordance with an embodiment of the invention. In FIG. 3, the options menu 200 is displayed on a television screen 340 of a data processing system 300 as a part of that system's GUI 380. In this embodiment, the data processing system 300 is a television or a set-top box and the input device 310 may be a remote control unit for the television or set-top box. In FIG. 5, the options menu 200 is displayed on a display screen of 340 of a data processing system 300 as part of that system's GUI 380. In the embodiment of FIG. 5, the data processing system 300 is a wireless PDA which includes an input device 310 in the form of a keypad.

The options menu 200 provides a list or choice of services 210. The list of services 210 includes a web button 211 for selecting an Internet service, a phone/cell button 212 for selecting a wired or wireless telephone service, a television button 213 for selecting a television service, and a SMS/MSN button 214 for selecting an IM service. Of course, the list of services 210 may include other or more services provided by the SP. The list of services 210 shown in FIG. 3 may represent the services to which the subscriber has subscribed.

In addition, the options menu 200 provides a list or choice of users 220. The list of users 220 includes a first user button (labelled “Mary”) 221 for selecting to configure access and content for the first user, a second user button (labelled “John Jr.”) 222 for selecting to configure access and content for the second user, and a third user button (labelled “Billy”) 223 for selecting to configure access and content for the third user. Of course, the list of users 210 may include other or more users. The list of users 220 shown in FIG. 3 may represent the children of the subscriber (i.e., their parent or guardian).

By selecting a button 211, 212, 213, 214 from the list of services 210, the user may configure access and content on a per service basis. By selecting a button 221, 222, 223 from the list of users 220, the user (i.e., the parent) may configure access and content on a per user (i.e., per child) basis. And, by selecting a button (e.g., 213, 223) from each of the lists 210, 220, the user may configure access and content on both a per service and per user basis (e.g., television service 213 for Billy 223).

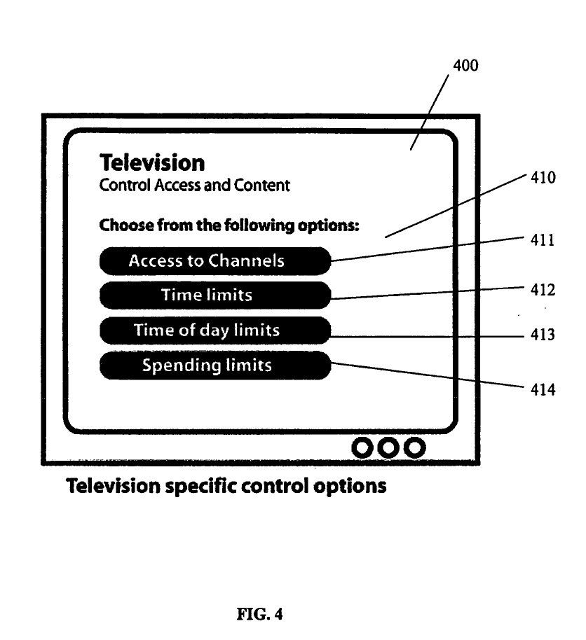

FIG. 4 is a screen capture illustrating a television service control options menu 400 in accordance with an embodiment of the invention. Upon selecting a service (e.g., television 213) in the list of services 210, the user is presented with a service control options menu (e.g., television service control options menu 400) from which various control functions may be selected relating to the selected service. For example, the television service control options menu 400 provides a list or choice of controls 410 for controlling access to the television service 213. These controls 410 maybe considered as different strategies for controlling access to the selected service 213. The list of controls 410 includes an access to channels button 411 for selecting to configure access to television channels provided by the SP (i.e., a channel selection control strategy), a time limits button 412 for selecting to configure time limits applicable for television viewing (i.e., a duration of usage control strategy), a time of day limits button 413 for selecting to configure time of day limits for television viewing (i.e., a time of usage control strategy), and a spending limits button 414 for selecting to configure an amount of money available for spending on television viewing (e.g., pay-per-view) (i.e., a value of usage control strategy). Of course, the list of controls 410 may include other or more controls supported by the SP. The list of controls 410 shown in FIG. 4 may represent the controls supported by the SP for the services to which the subscriber has subscribed.

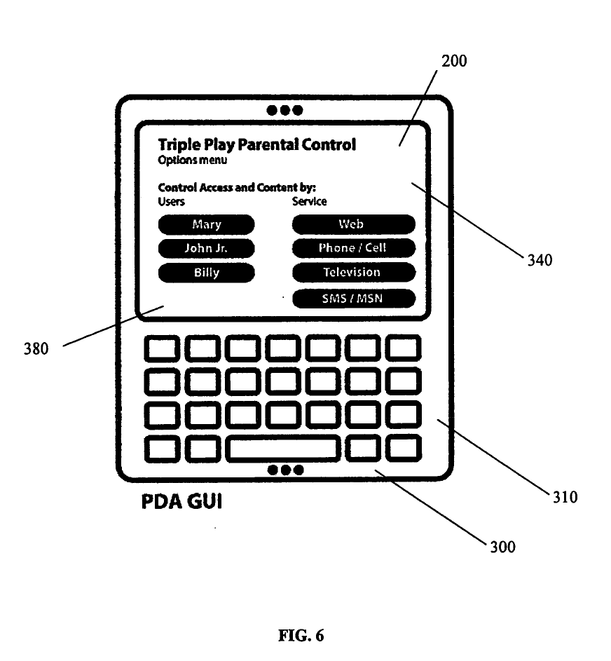

FIG. 5 is a screen capture illustrating a television service time limits configuration window 500 in accordance with an embodiment of the invention. Upon selecting a control (e.g., television service time limits 412) in the list of controls 410, the user is presented with a configuration window (e.g., television service time limits configuration window 500) a from which various parameters may be configured relating to the selected control. For example, the television service time limits configuration window 500 provides a list or choice of parameters 510. The list of parameters 510 includes a day parameter field 520 for entering a day of the week and a total time parameter field 530 for entering a total number of hours per day. In FIG. 5, the user has entered “Monday” as the day parameter 521 in the day parameter field 520 and “2 hours only” as the total time parameter 531 in the total time parameter field 530. The user may make these entries by directly entering parameter values (e.g., “Monday”, “2”) in respective fields 520, 530 using a keypad 310. Or, the user may make these entries by selecting an item from a pull down menu (not shown) available through respective menu key buttons 522, 532 provided for each field 520, 530. Direct entry is available when the data processing system 300 is a PC or a PDA configured with a keypad 310 as shown in FIG. 6. Menu selection entry is always available and is especially useful when the data processing system 300 is a television and/or set-top box equipped with a simple remote control unit 310 as shown in FIG. 3. Upon selecting a parameter for each field 520, 530, the configuration may then be saved by selecting the “Save Changes” button 540. This process may be repeated for each day of the week, etc.

The parameters 521, 531 are then sent in a message from the data processing system 300 to the server 120 over the network 110. The message may consist of one or more IP packets (i.e., for an IP based network) and may include an ID (i.e., a user ID, a data processing system ID, etc.) and a password for the user. Upon receiving the message, the server 120 configures the service in accordance with the received parameters 521, 531. In the case of the above television service 213 example, the server will restrict transmission of television service to the television 300 (for which the configuration was performed) to “2 hours only” on “Monday”.

According to one embodiment, a user may configure controls for a service (e.g., television service) using a data processing system other than that on which the service (i.e., the television service) will be provided. In this case, the data processing system on which the service is provided may be referred to as the target system. For example, a parent may log-in to the server 120 using a PC at his or her workplace. The parent may then configure controls for television service provided to a television (i.e., the target system) at the parent's home. Thus, the parent may remotely configure controls for television viewed by his or her children.

According to one embodiment, with respect to configuring access to the wireless or wired telephone service through the phone/cell button 212, the corresponding telephone service control options menu (not shown) may list a control for restricting telephone service to selected telephone numbers. For example, parameters for this control may be the telephone number(s) of a child's parents. In this case, the child (e.g., Billy 223) would be restricted to placing calls only to his or her parents. Similarly, with respect to configuring access to the IM service through the SMS/MSN button 214, the corresponding IM service control options menu (not shown) may list a control for restricting IM service to selected IM addresses. For example, parameters for this control may be the IM address(es) of the child's parents. In this case, the child would be restricted to sending SMS/MSN messages only to his or her parents.

According to one embodiment, with respect to configuring access to the Internet service through the web button 211, the corresponding Internet service control options menu (not shown) may list a control for restricting Internet access to web sites that are approved for children or that are specifically designated for access by the a child's parents (i.e., through corresponding parameters). Similarly, with respect to configuring access to the television service through the television button 213, the corresponding television service control option menu 400 may list a control (not shown) for restricting television access to programs that are rated for children (e.g., “G”, “PG-13”, etc.).

The present invention provides several advantages. It provides an easy to use, centralized control panel or GUI 200, 400, 500 allowing parents/guardians simplified and unified control over access and content available to their family members. In provides a control panel or GUI 200, 400, 500 that is available from almost any device (i.e., PC, TV, wireless devices, etc.). In provides for the control of all triple play services available from a SP. It allows a first SP to differentiate itself from a second SP by allowing a subscriber to control only those services in the bundle of services offered by the first SP (i.e., not the services offered by the second SP). This allows the first SP to promote complete service bundling and to improve subscriber retention. It allows the SP to promote the “no worry” value of its services to parents. And, it allows parents/guardians to control the amount of time, time of day, dollars spent, content, contacts, etc., for services offered by the SP.

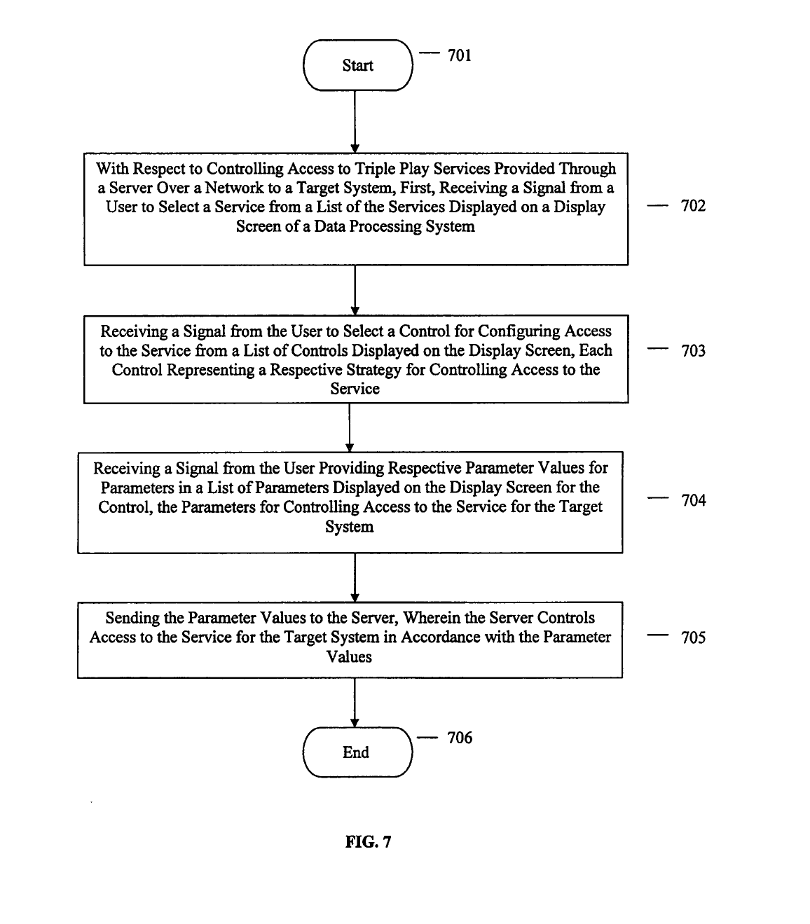

The above described method may be summarized with the aid of a flowchart. FIG. 7 is a flow chart illustrating operations 700 of modules 331 within the memory 330 of a data processing system 300 for controlling access to triple play services 211, 212, 213, 214 provided through a server 120 over a network 110 to a target system (e.g., 300), in accordance with an embodiment of the invention.

At step 701, the operations 700 start.

At step 702, a signal is received from a user to select a service (e.g., 213) from a list 210 of the services 211, 212, 213,214 displayed 200 on a display screen 340 of the data processing system 300.

At step 703, a signal is received from the user to select a control (e.g., 412) for configuring access to the service 213 from a list 410 of controls 411, 412, 413, 414 displayed 400 on the display screen 340, each control (e.g., 412) representing a respective strategy for controlling access to the service 213.

At step 704, a signal is received from the user providing respective parameter values 521, 531 for parameters 520, 530 in a list 510 of parameters 520, 530 displayed 500 on the display screen 340 for the control 412, the parameters values 521, 531 for controlling access to the service 213 for the target system (e.g., 300).

At step 705, the parameters values 521, 531 are sent to the server 120, wherein the server 120 controls access to the service 213 for the target system (e.g., 300) in accordance with the parameter values 521, 531.

At step 706, the operations 700 end.

In the above method, the services may be one or more of television service 213, wired telephone service 212, cellular telephone service 212, wireless data service 212, wireless email service 212, Internet service 210, and short message service 214. The controls for the television service 212 may be one or more of channel selection 411, duration of usage 412, time of usage 413, and value of usage 414. The parameters for the time of usage control 413 may be one or more of day of week 520 and total hours 530. The data processing system 300 may be collocated with the target system 300. The network 110 may be an IP based network. And, the data processing system 300 and the target system (e.g., 300) may be one or more of a television, a computer, a wireless device, a cellular telephone, a personal digital assistant, and a set-top box.

According to one embodiment of the invention, the above described method may be implemented by the server 120 rather than by the data processing system 300.

While this invention is primarily discussed as a method, a person of ordinary skill in the art will understand that the apparatus discussed above with reference to a data processing system 300, may be programmed to enable the practice of the method of the invention. Moreover, an article of manufacture for use with a data processing system 300, such as a pre-recorded storage device or other similar computer readable medium including program instructions recorded thereon, may direct the data processing system 300 to facilitate the practice of the method of the invention. It is understood that such apparatus and articles of manufacture also come within the scope of the invention.

In particular, the sequences of instructions which when executed cause the method described herein to be performed by the data processing system 300 of FIG. 2 can be contained in a data carrier product according to one embodiment of the invention. This data carrier product can be loaded into and run by the data processing system 300 of FIG. 2. In addition, the sequences of instructions which when executed cause the method described herein to be performed by the data processing system 300 of FIG. 2 can be contained in a computer software product according to one embodiment of the invention. This computer software product can be loaded into and run by the data processing system 300 of FIG. 2. Moreover, the sequences of instructions which when executed cause the method described herein to be performed by the data processing system 300 of FIG. 2 can be contained in an integrated circuit product (e.g., hardware modules) including a coprocessor or memory according to one embodiment of the invention. This integrated circuit product can be installed in the data processing system 300 of FIG. 2.

The embodiments of the invention described above are intended to be exemplary only. Those skilled in this art will understand that various modifications of detail may be made to these embodiments, all of which come within the scope of the invention.

What is claimed is:

1. A method for controlling access to triple play services provided through a server over a network to a target system, the method comprising:
receiving a signal from a user to select a service from a list of the services displayed on a display screen of a data processing system;
receiving a signal from the user to select a control for configuring access to the service from a list of controls displayed on the display screen, each control representing a respective strategy for controlling access to the service;
receiving a signal from the user providing respective parameter values for parameters in a list of parameters displayed on the display screen for the control, the parameters for controlling access to the service for the target system; and, sending the parameter values to the server, wherein the server controls access to the service for the target system in accordance with the parameter values.

2. The method of claim 1 wherein the services are one or more of television service, wired telephone service, cellular telephone service, wireless data service, wireless email service, Internet service, and short message service.

3. The method of claim 2 wherein the controls for the television service are one or more of channel selection, duration of usage, time of usage, and value of usage.

4. The method of claim 3 wherein the parameters for the time of usage control are one or more of day of week and total hours.

5. The method of claim 1 wherein the data processing system is collocated with the target system.

6. The method of claim 1 wherein the network is an IP based network.

7. The method of claim 1 wherein the data processing system and the target system are one or more of a television, a computer, a wireless device, a cellular telephone, a personal digital assistant, and a set-top box.

8. A system for controlling access to triple play services provided through a server over a network to a target system, the system comprising:
a processor coupled to memory, a display screen, and an input device; and,
modules within the memory and executed by the processor, the modules including:
a module for receiving a signal from a user to select a service from a list of the services displayed on a display screen of the system;
a module for receiving a signal from the user to select a control for configuring access to the service from a list of controls displayed on the display screen, each control representing a respective strategy for controlling access to the service;
a module for receiving a signal from the user providing respective parameter values for parameters in a list of parameters displayed on the display screen for the control, the parameter values for controlling access to the service for the target system; and,
a module for sending the parameter values to the server, wherein the server controls access to the service for the target system in accordance with the parameter values.

9. The system of claim 8 wherein the services are one or more of television service, wired telephone service, cellular telephone service, wireless data service, wireless email service, Internet service, and short message service.

10. The system of claim 9 wherein the controls for the television service are one or more of channel selection, duration of usage, time of usage, and value of usage.

11. The system of claim 10 wherein the parameters for the time of usage control are one or more of day of week and total hours.

12. The system of claim 8 wherein the system is collocated with the target system.

13. The system of claim 8 wherein the network is an IP based network.

14. The system of claim 8 wherein the system and the target system are one or more of a television, a computer, a wireless device, a cellular telephone, a personal digital assistant, and a set-top box.
